(19) United States
(12) Patent Application Publication
(10) Pub. No.: US 2025/0141037 A1
(43) Pub. Date: May 1, 2025

(54) GAS FLOW VENT SYSTEM FOR A BATTERY CELL

(71) Applicant: GM Global Technology Operations LLC, Detroit, MI (US)

(72) Inventors: Hwanchul Kim, Dryden, MI (US); Raghavendra Keerthi Manda, Northville, MI (US); Subrahmanyam Goriparti, Troy, MI (US); Vincent Edward Herrman, Clawson, MI (US); Fengkun Wang, Rochester Hills, MI (US)

(21) Appl. No.: 18/499,622

(22) Filed: Nov. 1, 2023

(51) Int. Cl. H01M 50/367; B60L 50/50; H01M 50/209; H01M 50/249; H01M 50/289

(52) U.S. Cl. CPC H01M 50/367; B60L 50/50; H01M 50/209; H01M 50/249; H01M 50/289; H01M 2220/20

(57) ABSTRACT

A battery cell includes a gas flow vent system including a cell can having a plurality of walls that define a cell stack receiving zone. The plurality of walls include a vent surface including a vent opening and a gas flow guide surface. A cell stack is arranged in the cell stack receiving zone. A spacer is arranged in the cell stack receiving zone adjacent the gas flow guide surface. The spacer includes a first surface facing the cell stack and a second surface spaced from the gas flow guide surface so as to define a gas flow duct that channels gases from the cell stack to the vent opening.

### INTRODUCTION

The subject disclosure relates to the art of batteries and, more particularly, to a gas flow vent system for a battery cell.

Batteries include cells that store and release electrical energy. Each cell includes a cathode and an anode that are insulated one from another by a separator. An electrical storage media is connected to the cathode and the anode. The cells are typically secured in a housing and connected one, to another, to provide a desired energy output. Certain cells, particularly cells used in vehicle batteries, include an electrode stack that is arranged in a can and bathed in a liquid electrolyte material. The electrode stack may take on various forms including a jelly-roll geometry, a z-stack geometry, and the like.

Batteries including a liquid electrolyte or wet stacks typically produce a gas when being charged or discharged. The gas typically results a reaction between the electrolyte and the cathode and anode. The gas is typically stored in the cell and discharged through a vent once a selected pressure threshold and/or temperature threshold is reached. Discharging the gas reduces cell temperature and prevents undesirable can expansion that may affect neighboring cells. Accordingly, it is desirable to provide a gas flow vent system for a battery cell to increase gas venting.

### SUMMARY

A battery cell includes including a gas flow vent system, in accordance with a non-limiting example, includes a cell can including a plurality of walls that define a cell stack receiving zone. The plurality of walls include a vent surface including a vent opening and a gas flow guide surface. A cell stack is arranged in the cell stack receiving zone. A spacer is arranged in the cell stack receiving zone adjacent the gas flow guide surface. The spacer includes a first surface facing the cell stack and a second surface spaced from the gas flow guide surface so as to define a gas flow duct that channels gases from the cell stack to the vent opening.

In addition to one or more of the features described herein the spacer includes at least one opening that passes through the first surface and the second surface fluidically connecting the cell stack receiving zone with the gas flow duct.

In addition to one or more of the features described herein the spacer includes a first end and a second end spaced from the first end by the first surface and the second surface.

In addition to one or more of the features described herein the spacer includes a support arranged at and extending substantially perpendicularly from the second end, the support being arranged at the vent surface.

In addition to one or more of the features described herein the support includes a first end portion connected to the spacer at the second end, a second end portion, and an intermediate portion extending between the first end portion and the second end portion.

In addition to one or more of the features described herein the second end portion is spaced from the vent opening.

In addition to one or more of the features described herein the intermediate portion includes a passage that aligns with the vent opening.

In addition to one or more of the features described herein the plurality of walls includes another gas flow guide surface arranged opposite the gas flow guide surface.

In addition to one or more of the features described herein another spacer is coupled to the second end portion of the support, the another spacer including a third surface facing the cell stack and a fourth surface spaced from the another gas flow guide surface so as to define another gas flow duct that channels gases from the cell stack to the vent opening.

In addition to one or more of the features described herein the another spacer includes at least one opening that passes through the third surface and the fourth surface fluidically connecting the cell stack receiving zone with the another gas flow duct.

A vehicle, in accordance with a non-limiting example, includes a body, a drive unit supported in the body, and a rechargeable energy storage system (RESS) supported at the body and operatively connected with the drive unit. The RESS includes a battery cell having a gas flow vent system including a cell can having a plurality of walls that define a cell stack receiving zone. The plurality of walls include a vent surface including a vent opening and a gas flow guide surface. A cell stack is arranged in the cell stack receiving zone. A spacer is arranged in the cell stack receiving zone adjacent the gas flow guide surface. The spacer includes a first surface facing the cell stack and a second surface spaced from the gas flow guide surface so as to define a gas flow duct that channels gases from the cell stack to the vent opening.

In addition to one or more of the features described herein the spacer includes at least one opening that passes through the first surface and the second surface fluidically connecting the cell stack receiving zone with the gas flow duct.

In addition to one or more of the features described herein the spacer includes a first end and a second end spaced from the first end by the first surface and the second surface.

In addition to one or more of the features described herein the spacer includes a support arranged at and extending substantially perpendicularly from the second end, the support being arranged at the vent surface.

In addition to one or more of the features described herein the support includes a first end portion connected to the spacer at the second end, a second end portion, and an intermediate portion extending between the first end portion and the second end portion.

In addition to one or more of the features described herein the second end portion is spaced from the vent opening.

In addition to one or more of the features described herein the intermediate portion includes a passage that aligns with the vent opening.

In addition to one or more of the features described herein the plurality of walls includes another gas flow guide surface arranged opposite the gas flow guide surface.

In addition to one or more of the features described herein another spacer is coupled to the second end portion of the support, the another spacer including a third surface facing the cell stack and a fourth surface spaced from the another gas flow guide surface so as to define another gas flow duct that channels gases from the cell stack to the vent opening.

In addition to one or more of the features described herein the another spacer includes at least one opening that passes through the third surface and the fourth surface fluidically connecting the cell stack receiving zone with the another gas flow duct.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a rechargeable energy storage system (RESS) having a battery cell, in accordance with a non-limiting example;

FIG. 2 is a disassembled view of the RESS of FIG. 1 having a battery cell provided with a gas flow vent system, in accordance with a non-limiting example;

FIG. 3 is a perspective glass view of a battery cell including a gas flow vent system, in accordance with a non-limiting example;

FIG. 4 is a perspective view of first and second spacers of the gas flow vent system, in accordance with a non-limiting example;

FIG. 5 is a perspective view of a battery cell stack being arranged between the first and second spacers of FIG. 4, in accordance with a non-limiting example;

FIG. 6, is a perspective view of the battery cell stack being supported by the first and second spacers of FIG. 5, in accordance with a non-limiting example;

FIG. 7 is a cut away view of a cell can preparing to receive the battery cell stack and first and second spacers of FIG. 6; and

FIG. 8 is a perspective view of a first spacer connected to a second spacer of the as flow vent system, in accordance with another non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

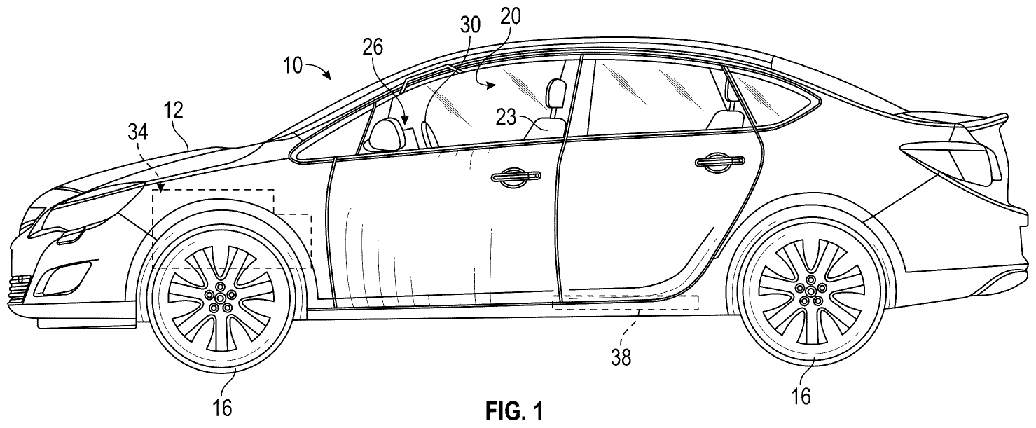

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control the orientation of select ones of the plurality of wheels 16. Vehicle 10 includes an electric drive unit 34 that provides power to one or more of the plurality of wheels 16.

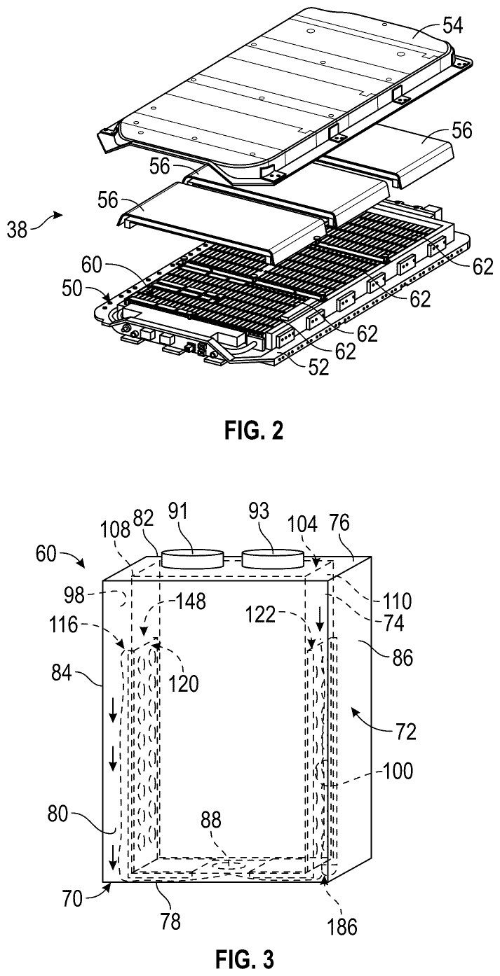

A rechargeable energy storage system (RESS) or battery assembly 38 is arranged in body 12 and provides power to electric drive unit 34. In other arrangements, a fuel cell (not shown) may be used to provide power to electric drive unit 34. At this point, it should be understood that the location of electric drive unit 34 and battery assembly 38 may vary. As shown in FIG. 2, RESS 38 includes a housing 50 having a base 52, an outer cover 54, and a number of inner covers 56. Inner covers 56 shield and protect a plurality of battery cells 60 arranged in a number of adjacent rows 62 on base 52.

Referring to FIG. 3, battery cell 60 includes a cell can 70 having a plurality of walls 72 that define a cell stack receiving zone 74. Plurality of walls 72 include a top wall 76, a bottom wall 78, a first side wall 80, a second side wall 82 arranged opposite first side wall 80, a third side wall 84, and a fourth side wall 86. Third side wall 84 and fourth side wall 86 extend between and connect with first side wall 80 and second side wall 82. In a non-limiting example, a vent opening 88 is arranged in bottom wall 78. Further, in a non-limiting example, top wall 76 supports an anode 91 and a cathode 93.

At this point, it should be understood that the terms top and bottom are only used to describe an exemplary aspect of cell can 70 as viewed in the figures. Top and bottom should not be considered limiting. Further, while the vent opening 88 is shown in the bottom or lower wall 78, the position of vent opening 88 may vary. Likewise, the position of anode 91 and cathode 93 may vary. That is, anode 91 and cathode 93 and vent opening 88 may be arranged in any of the plurality of walls 72 and need not be on upper and lower surfaces respectively.

In a non-limiting example, cell can 70 includes a first gas flow guide surface 98 and a second gas flow guide surface 100. A cell stack 104 is arranged in cell stack receiving zone 74 and connected with anode 91 and cathode 93. Cell stack 104 includes a first side surface 108 and a second side surface 110. First side surface 108 faces third side wall 84 and second side surface 110 faces fourth side wall 86. With this arrangement, a gas flow vent system 116 is arranged in cell stack receiving zone 74. As will be detailed herein, gas flow vent system 116 supports cell stack 104 and creates pathways along first gas flow guide surface 98 and second gas flow guide surface 100 to direct gases toward and through vent opening 88.

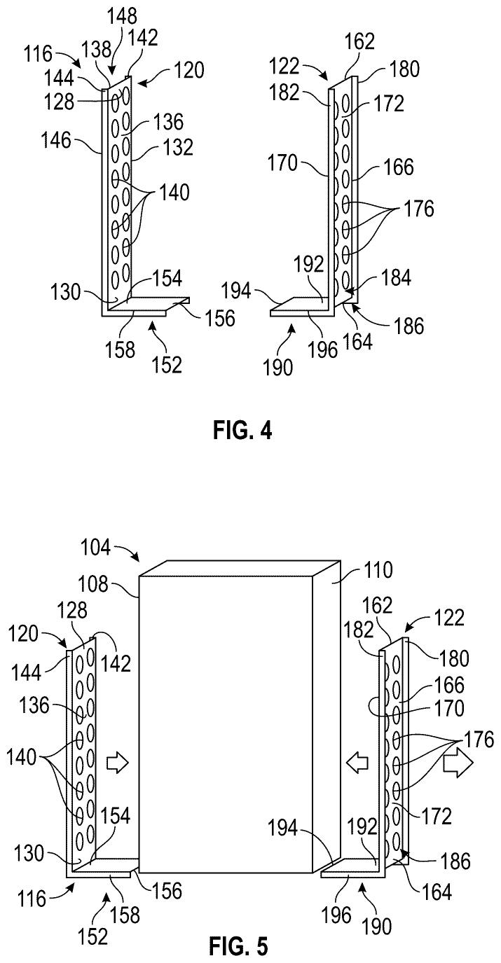

Referring to FIG. 4, gas flow vent system 116 includes a first spacer 120 and a second spacer 122. The number and position of spacers may vary. That is, gas flow vent system 116 may include as few as a single spacer or four or more spacers depending upon cell can design. First spacer 120 is arranged between first side surface 108 and first gas flow guide surface 98 of cell can 70 and second spacer 123 is arranged between second side surface 110 and second gas flow guide surface 100. As will be detailed herein, gas flow vent system 116 creates flow paths that guide gasses being emitted from or generated by cell stack 104 through vent opening 88. First spacer 120 and second spacer 122 are formed from a material that does not react with electrolyte.

In a non-limiting example, first spacer 120 includes a first end 128, a second end 130, and an intermediate section 132 extending between first end 128 and second end 130. Intermediate section 132 includes a first surface 136 and a second surface 138 that is opposite first surface 136. A plurality of openings 140 extend through intermediate section 132. A first projection 142 and a second projection 144 are formed on intermediate section 132. First projection 142 and second projection 144 are spaced one from another and extend between first end 128 and second end 130. First projection 142 and second projection 144 form a recess 146 that, when positioned adjacent first gas flow guide surface 98 forms a first gas flow duct 148. A first support 152 extends from first spacer 120. First support 152 includes a first end portion 154 connected to second end 130, a second end portion 156, and an intermediate portion 158 extending between first end portion 154 and second end portion 156.

Reference will continue to follow FIG. 4 in describing second spacer 122. In a manner similar to that discussed herein with respect to first spacer 120, second spacer 122 includes a first end section 162, a second end section 164, and an intermediate zone 166 extending between first end section 162 and second end section 164. Intermediate zone 166 includes a third surface 170 and a fourth surface 172 that is opposite third surface 170. A plurality of openings 176 extend through intermediate zone 166.

A first projection element 180 and a second projection element 182 are formed on intermediate zone 166. First projection element 180 and second projection element 182 are spaced one from another and extend between first end section 162 and second end section 164. First projection element 180 and second projection element 182 form a recess zone 184 that, when positioned adjacent second gas flow guide surface 100, form a second gas flow duct 186. A second support 190 extends from second spacer 123. Second support 190 includes a first end segment 192 that joins with second end section 164, a second end segment 194, and an intermediate segment 196 extending between first end segment 192 and second end segment 194.

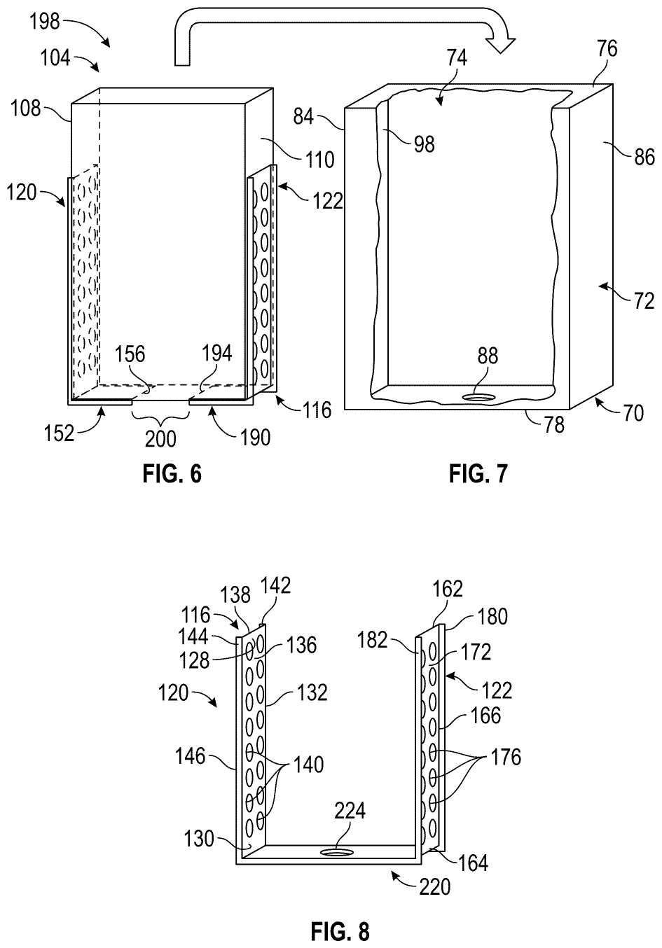

In a non-limiting example, cell stack 104 is arranged between first spacer 120 and second spacer 122 as shown in FIG. 5. First spacer 120 is shifted such that first surface 136 contacts first side surface 108 of cell stack 104 and second spacer 122 is shifted such that third surface 170 rests against second side surface 110 forming an assembly 198 shown in FIG. 6. In this configuration, cell stack 104 rests upon first support 152 and second support 190 with a gap 200 being created between second end portion 156 and second end section 194. At this point assembly 198 may be installed into cell stack receiving zone 74 as shown in FIG. 7. Once assembly 198 is installed in cell can 70, gap 200 aligns with vent opening 88.

In a non-limiting example, gases that may exit cell stack 104 may pass through the plurality of openings 140 in first spacer 120 and the plurality of openings 176 in second spacer 122. The gases flow into first gas flow duct 148 and second gas flow duct 186 respectively. The gases flow toward first support 152 and second support 190. The gases pass below first support 152 and second support 190 and pass through vent opening 88 to be passed to ambient. In another non-limiting example shown in FIG. 8, first spacer 120 and second spacer 122 may be joined by a support 220 having an opening 224. Opening 224 aligns with vent opening 88 when installed in cell can 70 to allow gases generated in or by cell stack 104 to pass from cell can 70. In addition to creating a path for gases to pass from cell can 70, first spacer 120 and second spacer 123 also reduce internal voids that may allow cell stack 104 to move when exposed to vibration or other external forces.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery cell including a gas flow vent system comprising:
a cell can including a plurality of walls that define a cell stack receiving zone, the plurality of walls including a vent surface including a vent opening and a gas flow guide surface;
a cell stack arranged in the cell stack receiving zone; and
a spacer arranged in the cell stack receiving zone adjacent the gas flow guide surface, the spacer including a first surface facing the cell stack and a second surface spaced from the gas flow guide surface so as to define a gas flow duct that channels gases from the cell stack to the vent opening.

2. The battery cell according to claim 1, wherein the spacer includes at least one opening that passes through the first surface and the second surface fluidically connecting the cell stack receiving zone with the gas flow duct.

3. The battery cell according to claim 1, wherein the spacer includes a first end and a second end spaced from the first end by the first surface and the second surface.

4. The battery cell according to claim 3, wherein the spacer includes a support arranged at and extending substantially perpendicularly from the second end, the support being arranged at the vent surface.

5. The battery cell according to claim 4, wherein the support includes a first end portion connected to the spacer at the second end, a second end portion, and an intermediate portion extending between the first end portion and the second end portion.

6. The battery cell according to claim 5, wherein the second end portion is spaced from the vent opening.

7. The battery cell according to claim 5, wherein the intermediate portion includes a passage that aligns with the vent opening.

8. The battery cell according to claim 5, wherein the plurality of walls includes another gas flow guide surface arranged opposite the gas flow guide surface.

9. The battery cell according to claim 8, further comprising another spacer coupled to the second end portion of the support, the another spacer including a third surface facing the cell stack and a fourth surface spaced from another gas flow guide surface so as to define another gas flow duct that channels gases from the cell stack to the vent opening.

10. The battery cell according to claim 9, wherein the another spacer includes at least one opening that passes through the third surface and the fourth surface fluidically connecting the cell stack receiving zone with the another gas flow duct.

11. A vehicle comprising:
a body;
a drive unit supported in the body;
a rechargeable energy storage system (RESS) supported at the body and operatively connected with the drive unit, the RESS including a battery cell having a gas flow vent system comprising:
a cell can including a plurality of walls that define a cell stack receiving zone, the plurality of walls including a vent surface including a vent opening and a gas flow guide surface;
a cell stack arranged in the cell stack receiving zone; and
a spacer arranged in the cell stack receiving zone adjacent the gas flow guide surface, the spacer including a first surface facing the cell stack and a second surface spaced from the gas flow guide surface so as to define a gas flow duct that channels gases from the cell stack to the vent opening.

12. The vehicle according to claim 11, wherein the spacer includes at least one opening that passes through the first surface and the second surface fluidically connecting the cell stack receiving zone with the gas flow duct.

13. The vehicle according to claim 11, wherein the spacer includes a first end and a second end spaced from the first end by the first surface and the second surface.

14. The vehicle according to claim 13, wherein the spacer includes a support arranged at and extending substantially perpendicularly from the second end, the support being arranged at the vent surface.

15. The vehicle according to claim 14, wherein the support includes a first end portion connected to the spacer at the second end, a second end portion, and an intermediate portion extending between the first end portion and the second end portion.

16. The vehicle according to claim 15, wherein the second end portion is spaced from the vent opening.

17. The vehicle according to claim 15, wherein the intermediate portion includes a passage that aligns with the vent opening.

18. The vehicle according to claim 15, wherein the plurality of walls includes another gas flow guide surface arranged opposite the gas flow guide surface.

19. The vehicle according to claim 18, further comprising another spacer coupled to the second end portion of the support, the another spacer including a third surface facing the cell stack and a fourth surface spaced from another gas flow guide surface so as to define another gas flow duct that channels gases from the cell stack to the vent opening.

20. The vehicle according to claim 19, wherein the another spacer includes at least one opening that passes through the third surface and the fourth surface fluidically connecting the cell stack receiving zone with the another gas flow duct.
